(19) United States
(12) Patent Application Publication
(10) Pub. No.: US 2006/0101277 A1
(43) Pub. Date: May 11, 2006

(54) Detecting and remedying unauthorized computer programs

(76) Inventors: Patrick A. Meenan, South Riding, VA (US); Sreekant Kotay, Reston, VA (US); Anthony A. Chiles, Manassas, VA (US); Renee Shomaker, Leesburg, VA (US); Guy Levy-Yurista, Rockville, VA (US)

Correspondence Address: FISH & RICHARDSON P.C., P.O. BOX 1022, MINNEAPOLIS, MN, 55440-1022, US

(21) Appl. No.: 10/989,605

(22) Filed: Nov. 17, 2004

Related U.S. Application Data
(60) Provisional application No. 60/626,471, filed on Nov. 10, 2004.

(51) Int. Cl. H04L 9/00

(52) U.S. Cl. 713/182

(57) ABSTRACT

To protect a client system from unauthorized programs, a scanner application for detecting particular unauthorized programs is maintained on a host system and periodically provided to a client system that executes the scanner application. Targeted solutions to particular types of unauthorized programs also are maintained on the host system and provided to the client system. If the scanner application detects an unauthorized program on the client system, a remedy that is targeted only to the detected unauthorized program is programmatically initiated to remedy the problem of the detected unauthorized program.

### CROSS REFERENCE TO RELATED APPLICATIONS

This application claims the benefit of U.S. Provisional Application No. XXXXXX, filed Nov. 10, 2004, and titled HOST-BASED DETECTION AND CORRECTION OF MALICIOUS SOFTWARE ON CLIENT SYSTEMS, which is incorporated by reference in its entirety.

### TECHNICAL FIELD

This description relates to detecting and remedying the effects of unauthorized computer programs.

### BACKGROUND

Unauthorized computer programs, such as viruses, worms, and spyware, may be transmitted to a computer system. Once present on a computer system, an unauthorized computer program may consume computer resources, such as storage space and memory capacity, interfere with the operation of the computer system, and/or use the computer system for malicious or inappropriate uses. Unauthorized computer programs may be detected and removed from a computer system.

### SUMMARY

In one general aspect, a client system is protected from unauthorized programs. A client is provided, in a communication session between the client system and a host system, with a scanning application to detect the presence of an unauthorized program on the client system. In response to detection of the presence of an unauthorized program, a remedy for the detected unauthorized program is executed at the client system. The remedy is provided to the client system from the host system and in the communication session that provided the scanning application.

Implementations may include one or more of the following features. For example, the remedy may be transmitted, in the communication session, to the client system from the host system and in response to detection of the presence of the unauthorized program. The presence of an unauthorized program may be detected based on current residence of the unauthorized program in memory of the client system or based on current operation of the unauthorized program at the client system.

Providing the scanning application may include providing a scanning application to be run in active memory and not to be stored on non-volatile storage of the client system. Providing the scanning application may include providing a first scanning application to be run in active memory of the client system and providing a second scanning application to be stored on non-volatile storage of the client system. A second scanning application that provides multiple remedies for multiple types of unauthorized programs may be provided to the client system in the communication session. The scanning application may be stored on non-volatile storage of the client system, the second scanning application may be substantially larger than the first scanning application, and the multiple remedies provided by the second scanning application may include remedies for types of unauthorized program other than the remedy for the detected unauthorized program executed in response to detection of the presence of unauthorized program by the first scanning application.

The establishment of the communication session between the client system and the host system may be detected. The scanning application may be provided to the client system in response to detection of the establishment of the communication session. Detecting establishment of the communication session between the client system and the host system may include detecting that a user of the client system has signed onto the host system.

Scanning of the client system to detect the presence of a form of unauthorized program on the client system may be enabled. Scanning of the client system may include periodic scanning of the client system during the communication session, or scanning only the random access memory of the client system to detect presence of a form of unauthorized program on the client system. The scanning application may only be resident in random access memory of the client system, or the scanning application may include code segments to detect particular unauthorized programs.

Implementations of the techniques discussed above may include a method or process, a system or apparatus, or computer software on a computer-accessible medium.

The details of one or more of the implementations are set forth in the accompanying drawings and description below. Other features will be apparent from the description and drawings, and from the claims.

### DESCRIPTION OF DRAWINGS

FIG. 1 is a block diagram of a communications system capable of detecting and remedying the effects of an unauthorized computer program on a client system.

FIGS. 2 and 4 are flow charts of processes for detecting and providing a remedy for an unauthorized program.

FIGS. 3 and 5 are illustrations of exemplary interfaces for setting user preferences for detecting an unauthorized program.

Like reference symbols in the various drawings indicate like elements.

### DETAILED DESCRIPTION

Techniques are described for protecting a client system from unauthorized programs. In general, a scanner application for detecting particular unauthorized programs is maintained on a host system and periodically provided to a client system that executes the scanner application. Targeted solutions to particular types of unauthorized programs also are maintained on the host system and provided to the client system. If the scanner application detects an unauthorized program on the client system, a remedy that is targeted only to the detected unauthorized program is programmatically initiated to remedy the problem of the detected unauthorized program.

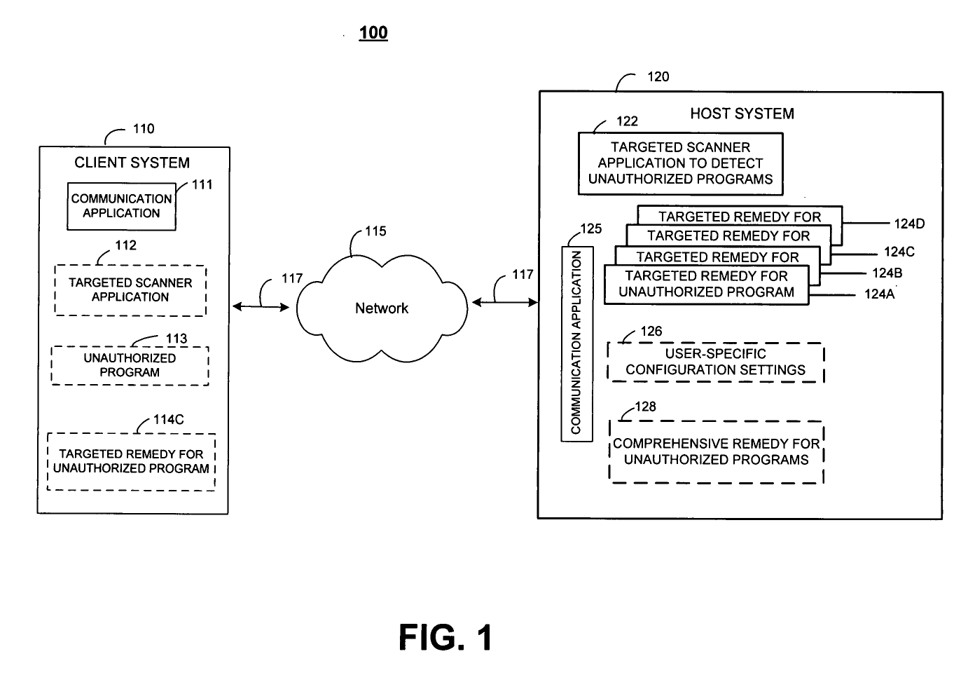

Referring to FIG. 1, a communications system 100 is capable of delivering and exchanging data between a client system 110 and a host system 120 through a delivery network 115 to help protect the client system 110 from unauthorized programs. In general, the host system 120 is capable of periodically providing to a client system 110 a scanner application 122 for detecting unauthorized programs. The scanner application 122, when stored on the client system 110, is referred to as the scanner application 112.

The host system 120 also is capable of providing one or more of remedies 124A-124D for unauthorized programs targeted by the scanner application 122. Each of remedies 124A-124D may be a computer program or an application that, when executed, remedies the effects of an unauthorized program on the client system 110. When stored on the client system 110, the remedies 124 are referred to as remedies 114. For example, as shown, the remedy 124C is stored on the client system 110 as remedy 114C.

The client system 110 periodically executes the scanning application 112 received from the host system 120 and, when an unauthorized program 113 is detected, the client system 110 applies a remedy 114C that is targeted for the detected unauthorized program 113. The execution of the scanning application may be triggered by the client system 110 or the host system 120.

More particularly, the client system 110 may be a general-purpose computer (e.g., a personal computer, a desktop computer, or a laptop computer) capable of responding to and executing instructions in a defined manner. Other examples of the client system 110 include a special-purpose computer, a workstation, a server, a device, a component, other physical or virtual equipment or some combination thereof capable of responding to and executing instructions. The client system 110 also may be, for example, a personal digital assistant (PDA), a communications device, such as a mobile telephone, or a mobile device that is a combination of a PDA and a communications device.

The client system 110 includes a communication application 111, and the client system 110 is configured to use the communication application 111 to establish a communication session with the host system 120 over the delivery network 115. The communication application 111 may be, for example, a general-purpose browser application or another type of communication application that is capable of accessing the host system 120. In another example, the communication application 111 may be a client-side application configured to communicate only with, or through, the host system 120.

The client system 110 also may include, in volatile memory (such as random access memory), the scanner application 112. The scanner application also may be referred to as a scanner program, a scanner computer program, a scanner script, or a scanner applet. The scanner application 112 may be transmitted from the host system 120 to the memory of the client system 110 and run from memory of the client system, which may eliminate the need to run a separate installation process to store the scanner application 112 in non-volatile or persistent storage of the client system. Examples of non-volatile storage include magnetic disks, such as internal hard disks and removable disks, and magneto-optical disks, such as Compact Disc Read-Only Memory (CD-ROM). By reducing, or eliminating, the need to install the scanner application 112 on non-volatile storage (e.g., a hard disk) on the client system 110, the length of time required to transmit the scanner application 112 to the client system 110 and/or complete the scanning operation may be reduced. The scanner application 112 may be stored on non-volatile storage and only transmitted to the client system 110 when the scanner application has been updated on the host system 120. This may result in saving bandwidth of the communication pathways 117 and eliminating time needed to transmit the scanner application 112 from the host system 120 when the scanner application 112 is the most current version.

In some implementations, the scanning application 112 is configured to detect only unauthorized programs that are executing on the client system 110. For example, the scanning application 112 may be configured to detect only a process of an unauthorized program running in memory of the client system 110 (rather than being configured to detect the presence of an unauthorized program on non-volatile storage of the client system 110). When the scanner application is configured to search only the memory of the client system and not to search persistent storage (e.g., a hard disk a CD-ROM or a DVD) of the client system, the amount of time needed to complete a scan of the client system 110 may be reduced.

In some implementations, the scanning application 112 may include unauthorized program definitions that are used to detect unauthorized programs. For example, the executable code of a scanning application may include unauthorized program definitions. Alternatively or additionally, the scanning application 112 may use definitions of unauthorized programs that are located outside of the scanning application itself. In one example, when executed, a scanning application may refer to unauthorized program definitions that are stored in memory of the client system.

One example of an unauthorized program, such as unauthorized program 113, is spyware that may be transmitted to a client system, used to monitor user activity on the client system, and used to transmit the gathered information through the network connection used by the client system without the user's consent or, perhaps, even without the user's knowledge. Information gathered through the spyware may be used for advertising purposes, including providing, without the user's consent, advertisements on the client system. Spyware uses memory of the client system and consumes bandwidth of the network connection to the client system, which may result in instability or failure of the client system. Other examples of unauthorized programs include viruses, worms, Trojan horses, and keyloggers that maintain a history of key strokes entered using a keyboard or keypad of a client system. An unauthorized program may be malicious software that is intended to do harm to the client system 110 or to use the client system 110 to cause harm to another computer system or the network 115.

Additionally or alternatively, the scanner application 112 may be configured to send, in response to detection of an unauthorized program 113, a message to the host system 120, which, in turn, may provide one or more of the targeted remedies 124A-124D for the unauthorized program or programs that are detected on the client system 110. In some implementations, the targeted remedies 124A-124D may be received by the client system along with the scanner application 112. In such a case, the scanner application 112 may be configured to select from among the provided targeted remedies and to apply only particular targeted remedies to remedy particular unauthorized programs detected on the client system 110.

The client system 110 is configured to receive from the host system 120 one or more targeted remedies. As illustrated, the client system 110 has the targeted remedy 114C for the unauthorized program 113 stored in memory. The targeted remedy 114C is a computer program configured to remedy problems caused by the unauthorized program 113 when the targeted remedy 114C is executed by a processor or processors of the client system 110. To do so, the unauthorized program may be removed from the client system or otherwise prevented from operating. For example, the unauthorized program may be removed from memory and initiation processes may be unhooked from the client system so that the unauthorized program is not re-started later. In one example, the unauthorized program may be removed from a start-up script or process that is executed when the client system is powered on or the operating system is initiated. In some cases, the unauthorized program may be removed from non-volatile storage or otherwise completely removed from the client system 110. However, it may be more efficient, and less disruptive to a user of the client system 110, to merely disable the unauthorized program and prevent the unauthorized program from re-starting (rather than removing the unauthorized program from non-volatile storage).

In some implementations, the scanning application 112 and one or more targeted remedies, such as targeted remedy 114C, may be provided together. In one example, the scanning application 112 and the targeted remedies corresponding to targeted remedies 124A-124D are included in a form-based scanning application 112 that is provided to the client system 110.

Transmitting and/or executing only the needed remedy for detected unauthorized programs may help to reduce disruption of, or interference with, as a result of remedying the client system. For example, by only transmitting a remedy for a particular unauthorized program or a small number of unauthorized programs, the size of the remedial computer program may be kept relatively small. A file that stores a remedial application may be small, and, as such, may be referred to as a light-weight application program or a light-weight solution. In some cases, for example, a remedial computer program may require a file size of only around 20 to 50 kilobytes.

In some implementations, when an unauthorized program is identified, a message is presented to inform the user that the unauthorized program is present. The remedial solution may be provided by the host system and executed to remedy the unauthorized program automatically or only after receiving confirmation from the user of the client system.

The delivery network 115 provides a direct or indirect communication link between the client system 110 and the host system 120, irrespective of physical separation. Examples of a delivery network 115 include the Internet, the World Wide Web, WANs, LANs, analog or digital wired and wireless telephone networks (e.g., PSTN (“Public Switched Telephone Network”), ISDN (“Integrated Services Digital Network”), and DSL (“Digital Subscriber Line”) including various forms of DSL such as SDSL (“Single-line Digital Subscriber Line”), ADSL (“Asymmetric Digital Subscriber Loop), HDSL (“High bit-rate Digital Subscriber Line”), and VDSL (“Very high bit-rate Digital Subscriber Line)), radio, television, cable, satellite, and/or any other delivery mechanism for carrying data.

The delivery network 115 also includes communication pathways 117 that enable the client system 110 and the host system 120 to communicate with the one or more delivery networks 115. Each of the communication pathways 117 may include, for example, a wired, wireless, virtual, cable or satellite communications pathway.

As with the client system 110, the host system 120 may be implemented using, for example, a general-purpose computer capable of responding to and executing instructions in a defined manner, a special-purpose computer, a workstation, a server, a device, a component, or other equipment or some combination thereof capable of responding to and executing instructions. The host system 120 may receive instructions from, for example, a software application, a program, a piece of code, a device, a computer, a computer system, or a combination thereof, which independently or collectively direct operations, as described herein. The host system 120 includes a communications application 125 that is configured to enable the host system 120 to communicate with the client system 110 through the delivery network 115.

The host system 120 may be a host system, such as, an Internet service provider, that provides services to subscribers. The host system 120 may be configured to provide the scanning application 122 to the client system 110 based on establishment of a communication session between the client system 110 and the host system 120. In addition, the scanner application is maintained—that is, updated to search for different types of unauthorized program—on the host system 120, which may help to reduce or eliminate the need for a user to take action to scan for unauthorized programs and/or to update the scanner application or definitions used by the scanner application to identify unauthorized programs.

The host system also may be configured to provide remedial applications 124A-124D to the client system 110 to be executed when a particular unauthorized program is detected on the client system 110. In some implementations, the host system 120 may be configured to provide all of the targeted remedies 124A-124D to the client system 110. Alternatively or additionally, the host system 120 may be configured to receive, from the scanner application 112 executing on the client system 110, an indication identifying one or more unauthorized programs and to provide to the client system 110 one or more of the targeted remedies 124A-124D that correspond to the one or more indicated unauthorized programs.

In some implementations, the host system 120 may include user-specific configuration information 126 that stores configuration settings preferred by a user and associated with the user's account. User preferences may be set or otherwise configured for a user account or a particular client system to control scanning and remediation of detected unauthorized programs. For example, a user account may be configured to scan only after a user confirms that a scan should occur. In another example, a user account may be configured to display a message reporting that an unauthorized program is detected or to identify a particular unauthorized program that is detected. In yet another example, a user account may be configured to run automatically (i.e., without user confirmation) a solution (e.g., a computer program that is a targeted remedy) that remedies the detected unauthorized program or to run the solution to remedy the detected unauthorized program only after confirmation by a user.

In another example, a comprehensive remedy 128 for unauthorized programs may be available from the host system 120 in addition to the targeted remedies 124A-124D for particular unauthorized programs. User-specific configuration settings 126 may include an indication of a user preference for scanning for one or more of unauthorized programs for which a targeted remedy is available or for scanning for unauthorized programs for which targeted remedies and comprehensive remedies are available.

In the example of FIG. 1, the client system is a client system of a subscriber to an Internet service provider (here, the host system 120). The scanning application 122 targets a limited number of unauthorized programs that are thought to be common in the ISP context (such as programs identified by the host system 120, programs thought to be common on the Internet in general, or programs thought to be common from popular Internet sites that subscribers to the host system 120 commonly visit) and/or thought to be disruptive to a user's experience, such as programs that cause disconnections between the client system 110 and the host system 120 or use bandwidth that interferes with the user's experience when connected to the host system 120. In other examples, unauthorized programs may be targeted based on their redirection of client-initiated requests to unintended web sites, their ability to cause communication application crashes in the address space of the communication application, and their display, on the client system, of content or advertisement based on client activity that occurs on the host system 120.

In a context of an Internet access provider or other service provider, a scanner application 122 may be transmitted to the client system 110 to identify spyware and other types of unauthorized programs each time a client system 110 is used to sign into a host system 120 of the Internet access or service provider. The scanner application 112, once resident on the client system 110, may be run periodically throughout the communication session. In one example, the scanner application 112 may be run every 10-20 minutes. Additionally or alternatively, the scanner application 112 may be run in response to a triggering event other than the passage of time. For example, the scanner application 112 may be run in response to a particular application being run on the host or a visit to a particular web site. In some implementations, the scanner application 112 and/or unauthorized program definitions used by the scanner application 112 also may be transmitted periodically throughout the communication session or based on a triggering event detected during the communication session. In another example, the scanner application 122 and/or one or more unauthorized program definitions may be transmitted in response to the receipt of an indication that the scanner application 112 and/or one or more of the unauthorized program definitions have been changed. Transmitting the scanner application 112 and/or unauthorized program definitions during the communication session may help to ensure that the client system is using the most recent scanner application and unauthorized program definitions.

In some implementations, the scanner application 112 may be configured to search for a subset of known unauthorized programs in the context of a particular environment. For example, in the context of an Internet service provider, the scanner application may be designed to identify a subset of known unauthorized programs based on the degree of interference of the unauthorized program on a subscriber's communication session. In one particular example, an unauthorized program that results in a high frequency of disconnections or other types of disruptions to a communication session may be selected for the scanner application 112 over other unauthorized programs may not be as common or as disruptive as the selected unauthorized program. By limiting unauthorized programs for which the scanner application searches, the file size of the scanner application may be reduced and, in some implementations, may be small, which, in turn, may reduce the amount of time needed to download the scanner application from the host system to the client system. A small scanner application may be referred to as a lightweight application. In some cases, for example, a scanner application may be as small as 5 to 20 kilobytes. A light weight scanner application may be useful, for example, in that the length of time required to download the scanner application and complete the scanning operation may be short, which, in turn, may help to reduce the impact of the scanning application on the user of the client system.

In some cases, for example, the user of the client system may be unaware that the scanning application is being downloaded and/or is scanning the client system. This may be true, for example, when the scanner application is a lightweight application that only scans the memory of the client system for a limited number of unauthorized program types or forms.

The host-based nature of the techniques for protecting a client system from unauthorized programs may be useful. For example, the scanning application may be dynamically changed on the host system and provided to multiple client systems without necessarily requiring action on the part of a client system user. This may enable a scanning application to be more tightly focused on unauthorized programs found in a particular computing environment. For example, an Internet service provider or other type of host system provider may be able to identify unauthorized programs that poses a significant threat to subscribers of the service and to target the identified unauthorized programs in a host-based scanning application. In another example, scanning application updates, updated unauthorized program definitions and/or updated remedial solutions may be automatically provided by the host system (e.g., the updates are pushed to the client system without requiring user manipulation of the client system), which may help better protect a client system from unauthorized programs.

In some implementations, multiple targeted scanning applications may be made available and provided based on an environmental factor or context of the client system. In one example, different targeted scanning application may be provided for different geographic regions, such as for different groups of countries (e.g., Pacific Rim, Europe, and South America) or different regions within a country (e.g., a northeastern region of the United States). In another example, a client system that is used by a first user who frequently visits web sites that are known to be origins of particular unauthorized programs may receive a different targeted scanning application than a client system that is used by a second user who does not visit the same web sites as visited by the first user.

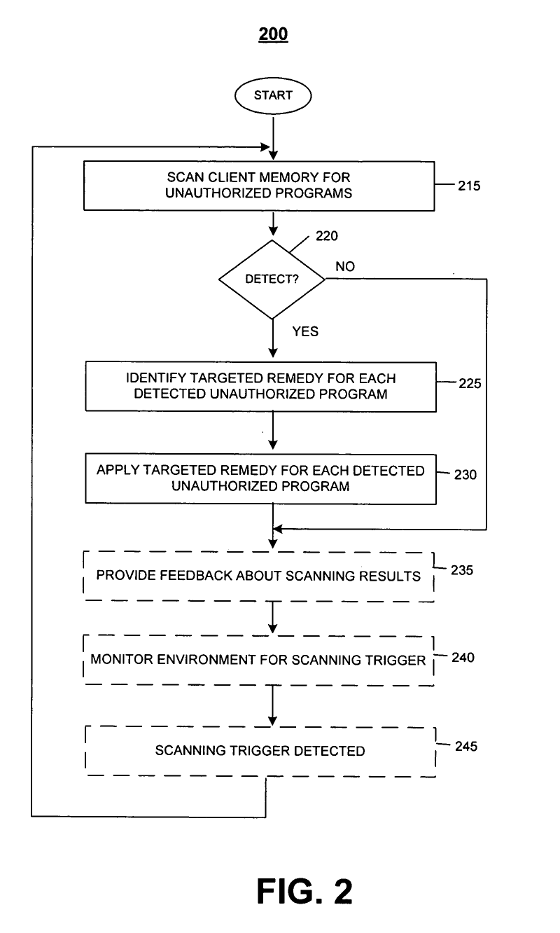

FIG. 2 illustrates a process 200 for detecting and providing a remedy for an unauthorized program. The process 200 may be performed by a client system that is executing a scanning application targeted for particular unauthorized programs, and, generally, a limited number of such unauthorized programs. In one example, a client system executing process 200 may be the client system 110 of FIG. 1 and may be engaged in a communication session with the host system 120. The client system executing the process 200 may be used by a subscriber of an Internet access or service provider of the host system. In such a case, the process 200 may begin, for example, when a user of the client system signs on to the host system, which, in turn, transmits the scanner application to the client system. The client system may receive the scanner application and use a processor or processors to execute the scanner application without necessarily storing the scanner application in non-volatile storage. In any case, a scanner application executing on a processor or processors of a client system may perform the process 200.

The processor scans the memory of the client system for unauthorized programs that are targeted by the scanner application (step 215). In some cases, the targeted unauthorized programs are programs that are thought to be common or to be particularly disruptive to a user of the client system. In general, the unauthorized programs that are targeted do not include all unauthorized programs for which scanning is available through a more comprehensive scanning application that also may be available to the client system.

To scan the memory of the client system, the processor may search for definitions of unauthorized programs. When scanning memory, the processor may look for particular process names that are running in memory to identify an unauthorized program that corresponds to a process name. In another example, the processor may look for a particular signature in memory that uniquely identifies an application. A signature of an application may be generated using a well-known or standardized process or algorithm designed to generate a unique signature. One example of such a signature is a MD5 hash signature. The processor may generate a MD5 hash signature for each application running in memory and look for match to a MD5 hash signature that is known to identify a particular unauthorized program. In another example, the processor may scan memory for particular identifiers that are assigned by an operating system producer or vendor to authors of applications designed to run using the operating system. For example, each plug-in application for a version of the Windows™ operating system from Microsoft Corporation of Redmond, Wash. is assigned a “class id” by Microsoft Corporation. To detect an unauthorized program, the processor may scan memory for particular class ids that are known to correspond to unauthorized programs. The processor may use MD5 hash signatures, class ids, process names or other types of process or application identifiers to scan memory to detect unauthorized programs. The processor also may scan well-known “activation” points in a computer system where an unauthorized program that is not necessarily currently running in memory may be detected. For example, an activation point may be a start-up folder that identifies programs or processes to be started automatically each time an operating system is started or may be a pluggable module that is automatically started when a browser is started. Scanning activation points may help to improve performance and may help to detect an unauthorized program that may not be currently running in memory.

In some implementations, definitions of the unauthorized programs may be included within the scanning application itself and/or, alternatively or additionally, the definitions of the unauthorized programs (e.g., the process names, class ids, or MD5 hash signatures for which to look in memory) may be stored separately, such as in a file or other type of list that is used by the scanning application. A list of unauthorized programs may be referred to as a blacklist.

When one or more unauthorized programs are detected (step 220), the processor identifies a targeted remedy for each of the detected unauthorized programs (step 225) and applies each of the targeted remedies (step 230). To do so, the processor may identify an association of a targeted remedy, such as a name and address of a computer program that, when executed, disables (or otherwise remedies the problems caused by) a detected unauthorized program. In one example, the processor may look up, on a blacklist, a targeted remedy that is associated with a detected unauthorized program. In another example, the scanning application itself may include information to initiate the execution of a remedy that is targeted to the detected unauthorized program. When applied, the targeted remedy may disable the unauthorized program from current and later operation, such as by removing the unauthorized program from memory and disabling any identified hooks that would otherwise enable the unauthorized program to be re-started later. The targeted remedy also may completely remove the unauthorized program from the client system, such as by removing (or making inaccessible) the unauthorized program from non-volatile storage of the client system.

The processor may provide feedback about scanning results (step 235). For example, the processor may present a message on the client system informing a user of the client system of the detection and/or removal of one or more unauthorized programs. In another example, the processor may send an indication of the unauthorized programs, if any, that were detected and whether any detected unauthorized programs were disabled. This information may be useful to help providers of a targeted scanning application select unauthorized programs to be included in the targeted scanning application.

In some implementations, the processor monitors the environment for a scanning trigger (step 240) and, when a scanning trigger is detected (step 245), repeats the scanning of the memory of the client system (step 215) and continues the process 200. Examples of scanning triggers include passage of a predetermined amount of time, request to access a particular web site or application, or a request to access a web site that is external to a host system that provided the scanner application. Whether the environment is monitored for a scanning trigger may be controlled by user or programmatic configuration such that some client systems are monitored and other client systems are not monitored.

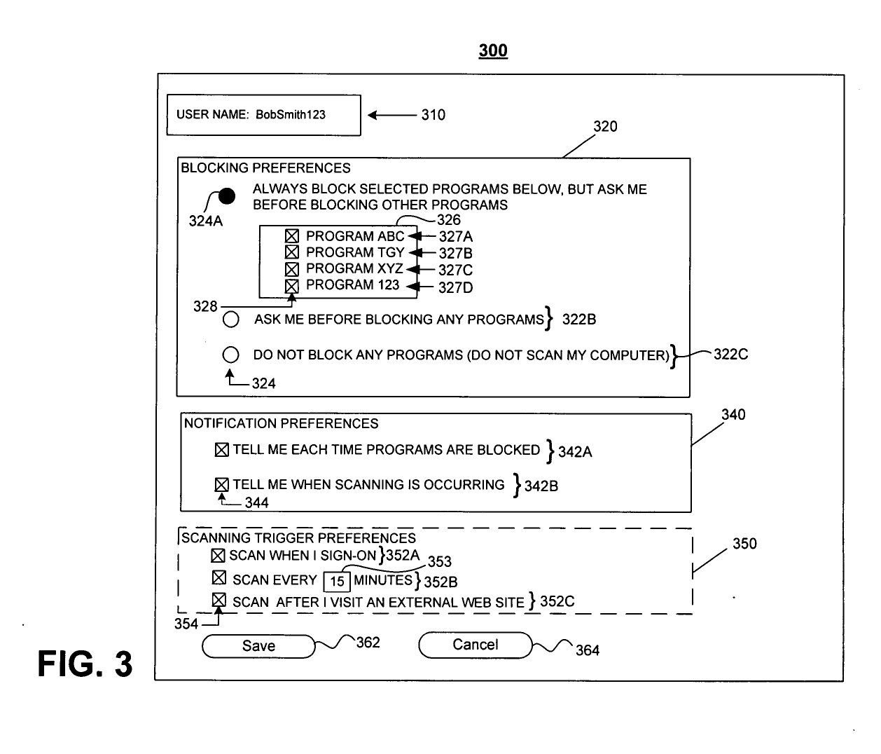

FIG. 3 shows an exemplary graphical user interface 300 for a communications system capable of enabling a user to set user preferences for detecting unauthorized programs. In general, the user interface 300 enables a user to select a preference to control which unauthorized programs are to be blocked and to set notification preferences that identify the types of messages presented when a client system is scanned. More particularly, the user interface 300 includes an account identification window 310 that identifies the user account for which scanning preferences identified in the user interface 300 are to be applied.

The user interface 300 also includes a window 320 that presents one or more blocking options 322A, 322B or 322C that are selectable through controls 324. As shown, the control 324A is selected such that the blocking option 322A is to be applied to the user account identified by the user account window 310. As illustrated, the blocking options 322A, 322B and 322C are mutually exclusive—that is, only one of the blocking options 322A, 322B or 322C may be selected.

Each of the blocking options 322A, 322B or 322C indicates how, if at all, unauthorized programs are scanned for and disabled. In particular, blocking option 322A represents automatically blocking unauthorized programs that are selected in a window 326 and scanning for other unauthorized programs, but not disabling other unauthorized programs until user confirmation is received to disable any other detected unauthorized programs. Here, the window 326 identifies unauthorized programs 327A, 327B, 327C and 327D, each of which may be selected through one of controls 328. As illustrated, any of the unauthorized programs 327A, 327B, 327C and 327D may be selected—that is, none, one, or more than one of the unauthorized programs 327A, 327B, 327C and 327D may be selected.

Blocking option 322B represents scanning for any unauthorized programs but not disabling any detected unauthorized programs (even programs identified in the window 326) until user confirmation is received to disable one or more of the detected unauthorized programs.

Blocking option 322C represents a preference to not scan the client system for any unauthorized programs.

The user interface 300 also includes a window 340 that presents notification options 342A or 342B, each of which may be selected using controls 344. The notification option 342A indicates a preference for display of a message each time a program is blocked. For example, the name of an unauthorized program that is detected and disabled may be displayed. Similarly, the notification option 342B indicates a preference to display a message when scanning is occurring. For example, a message may be displayed that indicates a scanning application is operating and/or performing a scan. A user is able to indicate, using controls 344, whether the user prefers to be notified as indicated by each notification preference 342A and/or 342B.

The user interface 300 may include a window 350 that presents scanning-trigger options 352A, 352B and 352C, each of which may be selected through one of controls 354 to be applied to the user account identified by window 310. Each of the scanning-trigger options 352A, 352B and 352C represents a trigger that may be selected to initiate the scanning preference identified in window 320. The option 352A represents scanning for the unauthorized programs identified in window 320 when a user uses the user account identified in window 310 to access a host system or service. The option 352B indicates a selectable preference to scan for unauthorized programs identified in window 320 periodically when a predetermined time criterion identified in field 353 has passed since the last scan was performed. Here, the option 352B represents a preference to initiate a scan every fifteen minutes. The option 352C indicates a selectable preference to initiate a scan for the unauthorized programs identified in window 320 after the user visits a web site that is external to the host system or service to which the user account identified in window 310 applies.

The user interface 300 also includes a save control 362 to persistently store the preferences identified in the user interface 300 and remove the interface 300 from the display, and a cancel control 364 to remove the interface 300 without saving the newly identified preferences.

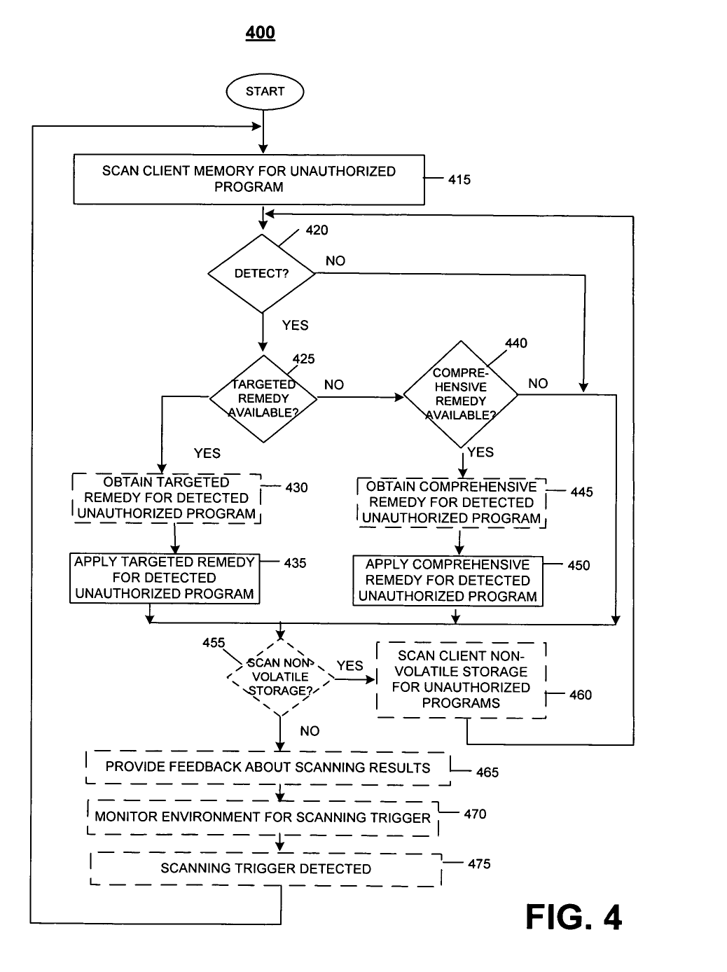

FIG. 4 depicts another process 400 for detecting and providing a remedy for an unauthorized program. In contrast to process 200 of FIG. 2, the process 400 includes detecting and disabling unauthorized programs for which a targeted remedy is available as well as detecting and disabling unauthorized programs for which a more comprehensive remedy is available. The process 400 is performed by a processor executing a scanning application. The process 400 may begin when a scanning application is provided by a host system to a client system.

The processor scans client memory for unauthorized programs (step 415). This may be accomplished as described previously with respect to step 215 of FIG. 2. When an unauthorized program is detected (step 420), the processor determines whether a targeted remedy is available the detected unauthorized program (step 425). This may be accomplished, for example, by looking up an identifier for an unauthorized program on a list of unauthorized programs for which targeted remedies are available.

When a targeted remedy is available for the detected unauthorized programs (step 425), the processor may obtain a targeted remedy for the detected unauthorized program (step 430). This may be accomplished, for example, by sending a message to the host system to obtain a targeted remedy for an unauthorized program or programs. In some instances, the targeted remedy may be available on the client system and, if so, the processor need not necessarily obtain the targeted remedy. The processor then applies the targeted remedy for each of the detected unauthorized programs for which a targeted remedy is available (step 435). For example, the processor may initiate a computer program that includes instructions for remedying the effects of the detected unauthorized program.

When a targeted remedy is not available for the detected unauthorized program (step 425), the processor determines whether a comprehensive remedy is available for any of the detected unauthorized program (step 440). To do so, the processor may search a list that indicates whether a comprehensive remedy is available for particular unauthorized programs. The list may be the same list as the list that indicates whether a targeted remedy is available for unauthorized programs, though this need not necessarily be so. When a comprehensive remedy is available, the processor may obtain the comprehensive remedy for the detected unauthorized program (step 445). Typically, obtaining a comprehensive remedy may be a more involved process than obtaining a targeted remedy. For example, obtaining a comprehensive remedy may include transmitting from a host system to the client system one or more large computer programs that include comprehensive remedies for many unauthorized programs. In some implementations, the obtained comprehensive remedy may include remedies for a large number of unauthorized programs and/or may include more complex remedies, such as remedies that delete computer programs stored on non-volatile storage of the client system. After the comprehensive remedy is obtained, the processor applies the comprehensive remedy for the detected unauthorized program or programs (step 450).

In some implementations, the processor may optionally scan non-volatile storage for unauthorized programs (step 455 and 460). For example, a user may be permitted to set a preference to indicate whether non-volatile storage is scanned in addition to memory of the client system. When an unauthorized program is detected (step 420) and a targeted remedy is available (step 425), the processor may obtain and apply the targeted remedy, as previously described (steps 430 and 435). Similarly, when an unauthorized program is detected (step 420) and a comprehensive remedy is available (step 440), the processor may obtain and apply the comprehensive remedy, as previously described (steps 445 and 450).

The processor optionally may provide feedback about scanning results (step 465), monitor the environment for a scanning trigger or triggers (step 470) and, when a scanning trigger is detected (step 475), scan the memory of the client system for unauthorized programs (step 415) and continue as previously described.

In some implementations, a targeted scanning application and a comprehensive scanning application may be provided from a host system. The targeted scanning application may scan for only unauthorized programs for which a targeted remedy is available. In contrast, the comprehensive scanning application may scan for unauthorized programs for which a comprehensive remedy is available. In some implementations, an unauthorized program for which a targeted remedy is available may also have available a comprehensive remedy that may be the same as, or different from, the targeted remedy for the unauthorized program.

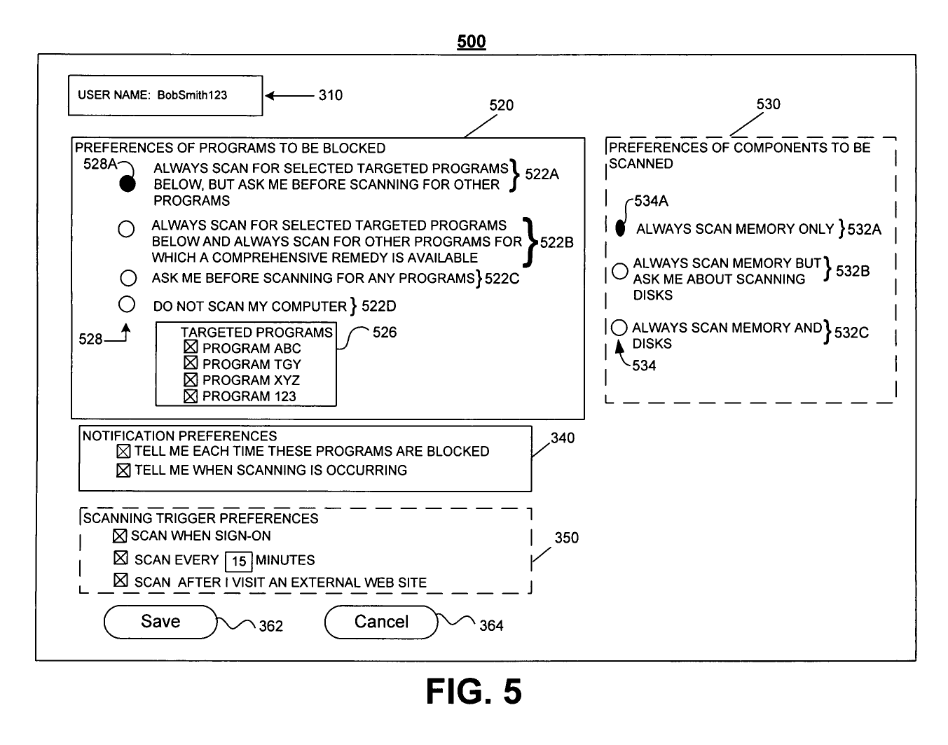

FIG. 5 is another exemplary graphical user interface 500 for a communications system capable of enabling a user to set user preferences for detecting unauthorized programs. In general, the user interface 500 enables a user to select a preference to control which unauthorized programs are to be blocked and to set notification preferences that identify the types of messages presented when a client system is scanned. In contrast with the user interface 300 of FIG. 3, the user interface 500 enables a user to set preferences for using a targeted scanning application and a comprehensive scanning application as well as to control the types of components of the client system that are scanned.

More particularly, the user interface 500 includes an account identification window 310, a notification-preference window 340, a scanning-trigger-preference window 350, a save control 362, and a cancel control 364.

The user interface 500 also includes a blocking window 520 that enables a user to identify which of mutually exclusive blocking options 522A, 522B, 522C or 522D are to be applied to the user account identified by window 310. One of controls 528 may be used to indicate that a blocking option corresponding to the selected control is to be applied. As shown, control 528A is selected and, as such, indicates that option 522A is to be applied to the user account identified in the account window 310. Like the user interface 300, the window 520 enables a user to select options related to a scanning application that is targeted to unauthorized programs identified in the window 526. In addition, and in contrast with the user interface 300, the window 520 enables a user to also select options relative to additional unauthorized programs, such as remedies available in a more comprehensive client protection application. The additional unauthorized programs may require more time-consuming remedies, may require more extensive scanning to detect, may be less likely to infect a client system, or may be less disruptive to a user's experience than the unauthorized programs identified in the window 526.

In particular, blocking option 522A represents automatically blocking unauthorized programs that are selected in window 526 and only scanning for other unauthorized programs once user confirmation is received. Blocking option 522B represents automatically blocking unauthorized programs that are selected in window 526 and automatically scanning for, and disabling, other unauthorized programs (without requesting user confirmation). Blocking option 522C represents a preference to only scan for unauthorized programs based on user confirmation to do so. Blocking option 522D represents a preference to not scan the client system for any unauthorized programs.

The user interface 500 also includes a window 530 that presents options 532A, 532B and 532C to control which of the components of the client system are scanned. Each of the options 532A, 532B and 532C may be selected through one of controls 534. As shown, control 534A is selected and, as such, option 532A is to be applied to the user account identified by window 310. The option 532A represents a preference to scan only the memory of the client system and to do so without first receiving confirmation from the user. The option 532B represents a preference to automatically scan the memory of the client system without first getting confirmation from the user and to scan non-volatile storage components of the client system only based on user confirmation. The option 532C represents a preference to automatically scan both the memory and non-volatile storage components of the client system without first getting confirmation from the user.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. As another example, a screen name is used throughout to represent a unique identifier of an account, but any other unique identifier of an account may be used when linking accounts. Accordingly, other implementations are within the scope of the following claims.

What is claimed is:

1. A method for protecting a client system from unauthorized programs, the method comprising:
providing a client, in a communication session between the client system and a host system, with a scanning application to detect the presence of an unauthorized program on the client system; and
in response to detection of the presence of an unauthorized program, executing, at the client system, a remedy for the detected unauthorized program wherein the remedy is provided, in the communication session, to the client system from the host system.

2. The method of claim 1 further comprising transmitting, in the communication session, to the client system from the host system the remedy in response to detection of the presence of the unauthorized program.

3. The method of claim 1 wherein detection of the presence of an unauthorized program comprises detection of current residence in memory of the client system of the unauthorized program.

4. The method of claim 1 wherein detection of the presence of an unauthorized program comprises detection of current operation of the unauthorized program at the client system.

5. The method of claim 1 wherein providing a scanning application comprises providing a scanning application to be run in active memory and not to be stored on non-volatile storage of the client system.

6. The method of claim 1 wherein providing a scanning application comprising providing a first scanning application to be run in active memory of the client system and a second scanning application stored on non-volatile storage of the client system.

7. The method of claim 1 wherein the scanning application is a first scanning application, the method further comprising making available to the client system a second scanning application that provides multiple remedies for multiple types of unauthorized programs, wherein:
the second scanning application is stored on non-volatile storage of the client system,
the second scanning application is substantially larger than the first scanning application, and
the multiple remedies provided by the second scanning application include remedies for types of unauthorized program other than the remedy for the detected unauthorized program executed in response to detection of the presence of unauthorized program by the first scanning application.

8. The method of claim 1 further comprising:
detecting establishment of the communication session between the client system and the host system; and
providing the scanning application to the client system in response to detection of the establishment of the communication session.

9. The method of claim 8 wherein detecting establishment of the communication session between the client system and the host system comprises detecting that a user of the client system has signed onto the host system.

10. The method of claim 1 further comprising enabling scanning of the client system to detect the presence of a form of unauthorized program on the client system.

11. The method of claim 10 wherein scanning of the client system comprises periodic scanning of the client system during the communication session.

12. The method of claim 10 wherein scanning of the client system comprises scanning only the random access memory of the client system to detect presence of a form of unauthorized program on the client system.

13. The method of claim 1 wherein the scanning application is only resident in random access memory of the client system.

14. The method of claim 1 wherein the scanning application comprises code segments stored in non-volatile storage medium to detect particular unauthorized programs.

15. A computer-readable medium or propagated signal having embodied thereon a computer program configured to protect a client system from unauthorized programs, the medium or signal comprising one or more code segments configured to:
provide a client, in a communication session between the client system and a host system, with a scanning application to detect the presence of an unauthorized program on the client system; and
in response to detection of the presence of an unauthorized program, execute, at the client system, a remedy for the detected unauthorized program wherein the remedy is provided, in the communication session, to the client system from the host system.

16. The medium of claim 15 wherein the one or more code segments are further configured to transmit, in the communication session, to the client system from the host system the remedy in response to detection of the presence of the unauthorized program.

17. The medium of claim 15 wherein detection of the presence of an unauthorized program comprises detection of current residence in memory of the client system of the unauthorized program.

18. The medium of claim 15 wherein detection of the presence of an unauthorized program comprises detection of current operation of the unauthorized program at the client system.

19. The medium of claim 15 wherein the one or more code segments configured to provide a scanning application comprise one or more code segments configured to provide a scanning application to be run in active memory and not to be stored on non-volatile storage of the client system.

20. The medium of claim 15 wherein the one or more code segments are further configured to provide a first scanning application to be run in active memory of the client system and a second scanning application stored on non-volatile storage of the client system.

21. The medium of claim 15 wherein:
the scanning application is a first scanning application, and
the one or more code segments are further configured to make available to the client system a second scanning application that provides multiple remedies for multiple types of unauthorized programs, wherein:
the second scanning application is stored on non-volatile storage of the client system,
the second scanning application is substantially larger than the first scanning application, and
the multiple remedies provided by the second scanning application include remedies for types of unauthorized program other than the remedy for the detected unauthorized program executed in response to detection of the presence of unauthorized program by the first scanning application.

22. The medium of claim 15 wherein the one or more code segments are further configured to:
detect establishment of the communication session between the client system and the host system, and
provide the scanning application to the client system in response to detection of the establishment of the communication session.

23. The medium of claim 15 wherein the one or more code segments are further configured to scan the client system to detect the presence of a form of unauthorized program on the client system.

24. The medium of claim 15 wherein the scanning application is only resident in random access memory of the client system.

25. The medium of claim 15 wherein the scanning application comprises code segments stored on non-volatile storage medium to detect particular unauthorized programs.

26. An apparatus protecting a client system from unauthorized programs, the apparatus being configured to:
provide a client, in a communication session between the client system and a host system, with a scanning application to detect the presence of an unauthorized program on the client system; and
in response to detection of the presence of an unauthorized program, execute, at the client system, a remedy for the detected unauthorized program wherein the remedy is provided, in the communication session, to the client system from the host system.

27. The apparatus of claim 26 further configured to transmit, in the communication session, to the client system from the host system the remedy in response to detection of the presence of the unauthorized program.

28. The apparatus of claim 26 wherein detection of the presence of an unauthorized program comprises detection of current residence in memory of the client system of the unauthorized program.

29. The apparatus of claim 26 wherein detection of the presence of an unauthorized program comprises detection of current operation of the unauthorized program at the client system.

30. The apparatus of claim 26 further configured to provide a scanning application to be run in active memory and not to be stored on non-volatile storage of the client system.

31. The apparatus of claim 26 further configured to provide a first scanning application to be run in active memory of the client system and a second scanning application stored on non-volatile storage of the client system.

32. The apparatus of claim 26 wherein the scanning application is a first scanning application, the apparatus further configured to make available to the client system a second scanning application that provides multiple remedies for multiple types of unauthorized programs, wherein:
the second scanning application is stored on non-volatile storage of the client system,
the second scanning application is substantially larger than the first scanning application, and
the multiple remedies provided by the second scanning application include remedies for types of unauthorized program other than the remedy for the detected unauthorized program executed in response to detection of the presence of unauthorized program by the first scanning application.

33. The apparatus of claim 26 further configured to:
detect establishment of the communication session between the client system and the host system; and
provide the scanning application to the client system in response to detection of the establishment of the communication session.

34. The apparatus of claim 26 further configured to scan the client system to detect the presence of a form of unauthorized program on the client system.

35. The apparatus of claim 26 wherein the scanning application is only resident in random access memory of the client system.

36. The apparatus of claim 26 wherein the scanning application comprises code segments stored on non-volatile storage medium to detect particular unauthorized programs.

37. A system for protecting a client system from unauthorized programs, the system comprising:
means for providing a client, in a communication session between the client system and a host system, with a scanning application to detect the presence of an unauthorized program on the client system; and
means for executing, at the client system and in response to detection of the presence of an unauthorized program, a remedy for the detected unauthorized program wherein the remedy is provided, in the communication session, to the client system from the host system.
